(19) United States
(12) Patent Application Publication
(10) Pub. No.: US 2023/0051340 A1
(43) Pub. Date: Feb. 16, 2023

(54) Dross Mitigation Method And Device in A MHD Printer

(71) Applicant: XEROX CORPORATION, Norwalk, CT (US)

(72) Inventors: Chu-Heng Liu, Penfield, NY (US); Jason M. Lefevre, Penfield, NY (US); Joseph C. Sheflin, Macedon, NY (US); Seemit Praharaj, Webster, NY (US); Douglas K. Herrmann, Webster, NY (US); David A. Vankouwenberg, Avon, NY (US); Linn C. Hoover, Webster, NY (US)

(73) Assignee: XEROX CORPORATION, Norwalk, CT (US)

(21) Appl. No.: 17/400,202

(22) Filed: Aug. 12, 2021

(51) Int. Cl. F27D 3/15; F27D 3/14

(52) U.S. Cl. CPC F27D 3/1572; F27D 3/14; B33Y 40/10

(57) ABSTRACT

The present disclosure discloses methods and systems for removing dross from a liquid metal chamber, such as would be used in magnetohydrodynamic (MHD) or metal 3D printing. The method and systems comprise inserting a dross removal tool into a liquid metal chamber. A seal is compromised, fluidically connecting an evacuated volume and the liquid metal chamber. Pressure equalizes between the fluidically coupled volumes through an inflow of gas, liquid, and solid components from the liquid metal chamber into the dross removal tool. The dross removal tool is removed from the liquid metal chamber.

### FIELD OF THE INVENTION

Disclosed is a method and tool for removing dross byproduct from a chamber containing liquid metal. A fixed, evacuated volume is fluidically coupled to a pool of liquid metal to remove dross by compromising a seal. In certain embodiments, a portion of the dross removal device is replaceable with each use. In certain embodiments, the seal is compromised through thermal energy from the melt chamber.

### BACKGROUND

In three-dimensional printing, also known as additive manufacturing, patterns are generally repeated on a printing surface. The successive drops on top of another eventually produce a three-dimensional object of virtually any shape. This additive manufacturing approach is extremely advantageous for many reasons including potential part complexity, distributed manufacturing capability, and cost. 3D printing has been the most successful, to this point, in creating plastic objects. Plastic objects are not the appropriate material for many applications due the build material properties being incompatible with the desired use, e.g. temperature resistance and/or working strength not being sufficient to the user's goal. Cost effective and high-quality metal 3D printing is highly desirable due its numerous advantages over traditional manufacturing techniques. There are different technological paths seeking to 3D print metal parts. A subset of these technological approaches uses a chamber of liquid metal. Liquid metal is moved from this chamber to a build surface through various deposition methods like magnetohydrodynamic (MHD) or some mechanical force.

In a typical 3D metal printer integrating a chamber of liquid metal, the operating temperature corresponds to the melting temperature required for the specific build material (e.g. Aluminum or aluminum alloy will require a lower operating temperature than a steel). During this high temperature operation, often exceeding 1000 C, oxidation can occur to the system materials of construction (chamber walls, nozzles, sensors, etc) and to the feed material entering the heated chamber. Most often, oxygen is the oxidizing agent in an oxidation reaction, but other agents may be partly or wholly responsible for the oxidation reaction. Oxygen often resides on the surface of feedstock and acts as the oxidizing agent. The result of the oxidation process is a conglomerate of oxide impurities with different material properties than the liquid metal intended for deposition. This conglomerate of impurities in the liquid metal is referred to as dross. Depending on the system temperature the dross can remain stable at the liquid metal temperatures, reduce into the liquid, or be a combination of the two states. Dross is generally a stable solid at the liquidus temperature of aluminum.

Dross is an unwanted byproduct that causes numerous and varied issues in a metal printing system. Dross particulates may partially or wholly block a jetting nozzle if drawn into the ejection flow. In addition, dross floating on the surface of the melt chamber may cause issues with the level sensors by adhering to the melt chamber walls or becoming a plug of material that does not rise and fall with the liquid metal height. The level sensor reading is a critical input parameter to the system software and inaccurate readings immediately impact build quality, height, and speed. Dross is a significant issue, impacting both build quality and directly increasing system operational costs. Dross management is a critical parameter for effective system performance. The successful commercialization of metal 3D printers utilizing chambers of liquid metal requires an effective solution to mitigate the negative impacts resulting from dross.

Dross volume increases in the melt chamber as a function of material throughput. As the dross builds up within the melt chamber it becomes a matter of time before the machine is shut down, proactively or reactively, due to the dross. As the dross builds, it becomes correspondingly more likely dross particulates will break from the larger floating mass and continue into the nozzle. The dross particulate has two potential outcomes once movement into the deposition stream occurs; either pass through or obstruct the print nozzle. Assuming the dross passes through the nozzle, significant damage can occur to the nozzle. The harder, oxide based dross scrapes and erodes the print nozzle surface, causing future issues with drop deposition and accuracy. In addition to damaging the nozzle during its passage, the dross can be deposited on the build structure and lacks compatibility with the structure being built. This dross deposition imperfection may result in a scrapped build, damage the platform, or risk acceptance evaluation of the compromised integrity of the structure. The second option after the dross enters the deposition stream is to fail to pass through the print nozzle, partially or wholly obstructing the nozzle. If undetected, the partial obstruction poses significant build quality issues as the system assumes a different flow rate and particulate path than the partially blocked nozzle allows. Eventually wholly or partially blocked nozzles are detected and a user must address the issue. This system is shutdown and typically requires complete replacement of the nozzle and any integrated or effected components. All failures lead to shutting down the machine, cleaning and removing the dross, replacing the effected components, and beginning a startup procedure again. This significantly impacts the system operational time and build cost.

### SUMMARY

Devices, systems, and methods are directed to removing dross from a chamber of liquid metal. A dross removal device is inserted into a liquid metal chamber of a 3D metal printer. A seal is compromised, fluidically coupling an evacuated volume with a chamber of liquid metal that includes a buildup of dross. Once the seal is compromised, the fluidically coupled volumes equalize in pressure by material inflow to the dross mitigation tool. The material inflow includes dross and may include some amount of liquid metal.

According to one aspect of the invention, there is provided method for removing dross from molten metal in a chamber. The method comprises inserting a dross removal tool into a chamber containing molten metal. The dross removal tool comprises a container defining an evacuated volume, a suction end, and a seal disposed between the suction end and the evacuated volume. The seal is compromised while the dross removal tool is inserted into the chamber, fluidically coupling the evacuated volume and the volume inside the chamber. The pressure equalizes between the fluidically coupled volumes through material inflow into the dross removal device, and material outflow from the chamber. Dross and some quantity of molten metal may be removed.

In another aspect of the invention, the dross removal comprises a container. The container defines an evacuated volume and comprises a device body, a suction end, and a seal between the evacuated end and the suction end.

Alternatively, in another aspect of the invention, the dross removal tool comprises a container. The container defines an evacuated volume and comprises a device body, a self-sealing valve, a suction end, and a seal between the suction end and the evacuated volume.

### BRIEF DESCRIPTION OF THE DRAWINGS

The foregoing summary, preferred embodiments, and other aspects of the present disclosure will be best understood with reference to a detailed description of specific embodiments.

FIG. 1 shows an exemplary metal printing system comprising a melt chamber, deposition nozzle, and build surface.

FIG. 2A discloses one exemplary embodiment of a dross removal device. FIG. 2B discloses a second exemplary embodiment of a dross removal device.

FIG. 3A shows an embodiment of a dross removal device with a self-sealing valve. FIG. 3B shows a second embodiment of a dross removal device with a self-sealing valve.

FIG. 4A shows an exemplary dross removal device positioned above the liquidus surface in an exemplary liquid metal chamber. FIG. 4B shows an exemplary dross removal device positioned below the liquidus surface in an exemplary liquid metal chamber.

FIG. 5A shows an embodiment of a dross removal device with a multi-material coupler member. FIG. 5B shows an embodiment of a dross removal device with a flexible portion of the coupler member. FIG. 5C shows an embodiment of a dross removal device with a convoluted coupler member.

### DETAILED DESCRIPTION

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

Certain terms used herein may be defined, for example, in embodiments herein, as follows. Dross, in embodiments herein, may refer to impurities desired to be removed from a quantity of liquid metal. Vacuum and evacuated, in embodiments herein, shall be used to broadly indicate a defined volume that is to some extent depressurized, relative to outside the defined volume, so as to cause air or other material to push into the volume when fluidically coupled to a second volume. Solder shall be used to broadly describe a fusible metal alloy used to create a bond with surrounding metal structures.

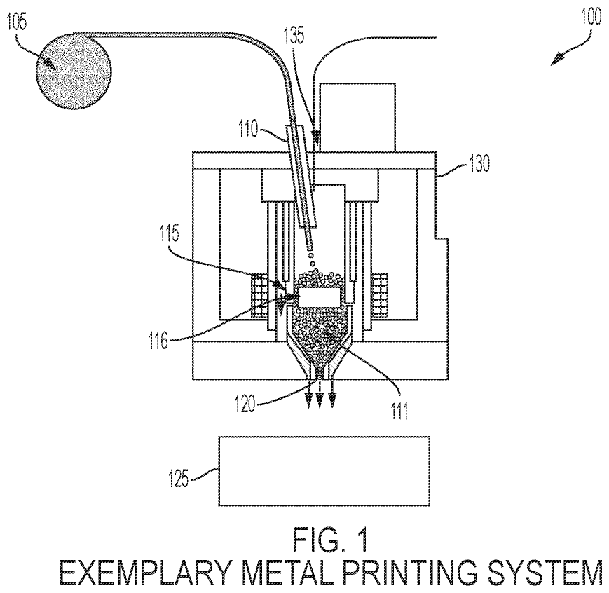

FIG. 1 illustrates an overview of an exemplary magnetohydrodynamic (MHD) liquid metal 3D printer 100 the present invention may be used with. Other types of liquid metal 3D printers may use the present invention in a similar manner. A wire feedstock 105 is fed into the system through a wire feed port 110. The wire passing through wire feed port 110 is guided into the melt chamber 115. In some embodiments of the printing system, the melt chamber 115 has a chamber manifold 130 that the wire feed port 110 and the gas feed port 135 pass through. As the wire feedstock 105 entered the melt chamber 115, the wire feedstock 105 is heated beyond the liquidus temperature corresponding to the feedstock material and becomes a portion of the liquid metal pool 111. The liquid metal pool 111 comprises of the liquidus form of wire feedstock 105 and an amount of dross 116. The dross 116 may be on the surface of the melt pool 111 or in any place through the melt chamber 115. The melt chamber 115 is fluidically coupled to an ejection nozzle 120. Molten metal, and erratically contamination like dross, flow from the melt chamber 115 through the ejection nozzle 120 to the build platform 125.

The wire feedstock 105 may materially comprise any type of metal or alloy. In some embodiments, the metal feed mechanism may be configured to accept a bar or block of the print metal. Aluminum, aluminum alloys, copper, copper alloys and different grades of steel are all exemplary wire feedstock options. Dross volume is highly dependent on the throughput of wire into the melt chamber 115.

The wire feed port 110 supports the wire feedstock 105 as it passes into the melt chamber 115. In some embodiments, the wire feed port 110 is removable. When removed, an unobstructed passage into the liquid metal chamber is available. In some embodiments of the invention, the dross mitigation tool utilizes this unobstructed passage instead of removing the chamber manifold 130. The dross removal device tip can be inserted through the open port into the liquid metal pool 111 and the dross removed.

The liquid metal pool 111 may be at varying heights within the melt chamber 115. As printing continues, the dross 116 is an increasingly larger percentage of the liquid metal pool 111. The dross 116 often floats, due to a density difference between the oxide that predominantly composes the dross and the liquid metal, and causes issues with float sensors by adhering to the walls of the melt chamber 115 and not rising and falling with the surface of the liquid metal pool 111. The dross, if pulled into a moving stream path, may be present anywhere in the liquid metal pool 111. Additionally, stiction may occur between the dross and the melt chamber 115 walls. For example, when the liquid metal pool 111 level changes, the dross may remain attached to the melt chamber 115 wall. The dross may remain attached stably, or slide up or down the melt chamber 115 wall due to the force of gravity or propensity to float and seek the surface of the liquid metal pool 111.

Molten metal from the liquid metal pool 111 passes through the ejection nozzle 120 to the build platform 125. Portions of dross may pass into the liquid metal deposition stream and into the ejection nozzle 120. The dross may wholly or partially obstruct the ejection nozzle 120, or pass through the ejection nozzle 120 and be deposited on the build platform 125.

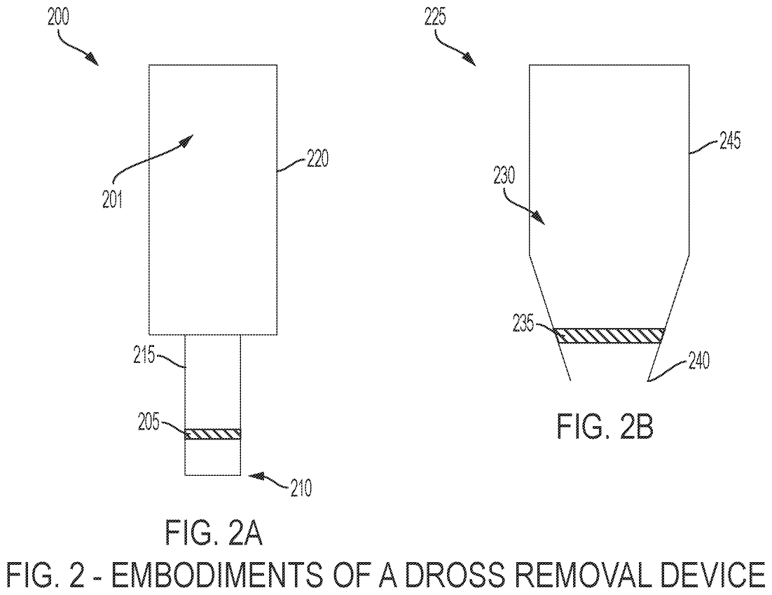

FIG. 2 illustrates two embodiments of a dross removal device. The dross removal device 200 or 225 is inserted into the melt chamber 115. The dross removal device 200 is an evacuated volume 201 defined by a device body 220. Dross removal device 225 is an evacuated volume 230 defined by a device body 245. In some embodiments, the dross removal device is inserted through the space created by removing the chamber manifold 130, but alternate insertion ports can be integrated for different system designs. The dross suction end 210 or 240 can effectively remove dross when placed into the liquid melt pool 111 at a point below the floating dross 116, or when placed in close proximity above the liquid metal pool 111 surface. The dross removal devices 200 and 225 are designed to be placed into the melt chamber 115 and delay a minimum amount of time before suction occurs. The delay time is a safety feature to allow the operator to install the dross mitigation tool and safely remove their hands. The heat from the melt chamber 115 eventually causes the mechanical integrity of the seal 205 or 235 to be compromised, and the evacuated volume 201 or 230 is fluidically coupled with a target volume. The pressure differential is equalized by the inflow of gas, liquid, and solid into the dross suction end 210 or 240. After dross, and a quantity of liquid metal, is removed from the melt chamber 115 the dross removal device 200 or 225 is removed from the melt chamber 115. The MFD liquid metal 3D printer 100 can now be reassembled for operation.

FIG. 2B illustrates another embodiment of a dross removal device 225. Dross removal device 225 has a device body 245 that encloses the fixed internal volume 230. The device body 245 terminates in a suction end 240. At least the suction end 245 is a material with a higher melt temperature than the operating temperature of the liquid metal pool 111. The fixed internal volume 230 is evacuated and the evacuated state is preserved through the seal 235. The dross removal device 225 can be evacuated and sealed in similar manners to other embodiments discussed below. FIGS. 2B and 2A operate with similar principles and improvements or modifications on one can be applied to the other.

The dross removal device 200 has a fixed internal volume 201 that corresponds to a volume of dross to be removed. The fixed internal volume 201 is typically larger than the volume of dross to be removed, to account for parasitic losses and flow inefficiencies in each system. The fixed internal volume 201 is enclosed by a device body 220 that is mechanically robust enough to maintain shape when the fixed internal volume 201 is evacuated. The device body 220 is connected to a coupler member 215. The coupler member 215 includes a seal 205 that preserves an evacuated state in the fixed internal volume 201. The coupler member 215 includes a dross suction end 210. In an embodiment of the present invention, the fixed internal volume 201, and fluidically coupled volumes, are evacuated. The evacuated volume is maintained by the seal 205. Once the seal 205 is installed, the dross removal device 200 maintains a vacuum state for extended periods of time.

The fixed internal volume 201 corresponds to a volume of dross to be removed. The volume 201 may be a scaled amount greater than the volume of dross to be removed in order to account for removal efficiencies like poor seals, non—linear flow due to size variations, and viscosity differences between liquid metal types. The fixed internal volume 201 may vary depending on the system size, liquid metal pool, and dross particulates for that specific system configuration.

The device body 220 is mechanically robust to withstand the corresponding forces from a full vacuum state of the fixed internal volume 301. In some embodiments of the present invention, the device body 220 is designed to be reusable. The device body 220 can be constructed of any mechanically robust material capable of withstanding a pressure differential of about 101.4 kPa.

The seal 205 can be installed successfully through different manufacturing approaches. One embodiment installs the seal 205 while the fixed internal volume 201 is evacuated. In other embodiments, the seal 205 is installed into the coupler member 215. The coupler member 215 is then attached to the device body 220 in an evacuated assembly chamber. The dross removal device 200 is capable of preserving the evacuated state for extended periods after assembly in an evacuated chamber. The dross removal device 200 can now be removed from the evacuated assembly chamber.

In one embodiment, the seal 205 comprises a metal disc bonded to the coupler member 215 through a solder. The solder bonds the metal disc to the coupler member 215, preserving the integrity of vacuum state during shipment and storage of the dross removal device 200. In other embodiments, the seal 205 comprises solder. In both embodiments, the seal is designed to lose integrity some amount of time after being inserted into the melt chamber 115. The temperature of the melt chamber 115 increases the temperature of the coupler member 215 and seal 205. The increased temperature causes the seal 205 to decrease in mechanical strength to the point the vacuum force of the internal volume 201 breaks the seal. Once compromised, the seal 205 is designed to be pulled into the internal volume 201 in addition to dross and some amount of liquid metal. In other embodiments, the seal 205 can be constructed of hard wax, ethylene-vinyl acetate (EVA), polyolefins, polyamides and polyesters, styrene block copolymers, polyethylene, and ethylene-methyl acrylate (EMA) or ethylene n-butyl acrylate (EnBA).

In alternative embodiments, the seal 205 is compromised by an external force applied to the coupler member. The external force may be mechanical in nature, e.g. applying force with a pinching tool. In some embodiments, the external force may be applied thermal energy to the coupler member by a user, e.g. applying a thermal load to some portion of the coupler member outside the melt chamber. The applied thermal load compromises the mechanical integrity of the seal 205 and fluidically couples the dross removal tool to the melt chamber.

The coupler member 215 fluidically couples the fixed internal volume 201 and the liquid metal pool 111. Once the seal 205 is compromised, dross and liquid metal are pulled into the dross removal device 200. In another embodiment, the coupler member 215 is designed to stop all dross 116, liquid metal, and compromised seal 205 from reaching the internal volume 201. Preventing the material inflow from the melt chamber 115 from reaching fixed internal volume 201 can occur by elongating the coupler member 215. Cooling occurs as the liquid metal and dross are pulled farther into the coupler member 215. The material inflow stops before reaching the fixed internal volume 201 due to a combination of molten metal becoming solid, particulates conglomerating and collecting into more solid obstructions with reduced flow capacity, and interactions between the material inflow and flow path geometries like bends or turns. After each use the coupler member 215 is inspected. If enough cross sectional area is unobstructed the coupler member 215 may be reused. In the present embodiment, the device body 220 can be reused multiple times. The coupler member terminates at a dross suction end 210. The coupler member 215 may be wholly or partially constructed of a material with a higher melting point than the pool of molten metal dross is being removed from. Exemplary materials of construction are metal and ceramic.

In alternative embodiments, adding one or more bends to the coupler member 215 prevents solid and liquid material inflow to the device body 220. The material inflow can be slowed to a stop in a straight length of coupler member that is sufficiently long. In some embodiments, bends are added to the coupler member that stop the material inflow in the coupler member 215 and allow passage of gas into the device body 220. The coupler member length required corresponds to the number and severity of bends that are appropriate for the inflow of liquid and solids to be stopped.

In alternative embodiments adding a filtering mechanism between the coupler member 215 and the device body 220 prevents material inflow to the device body 220. In some embodiments, the filter mechanism is a mesh sized to prevent the passage of the liquid metal or solid dross into the device body 220. In other embodiments, the filtering mechanism is an obstruction that stops material inflow and allows gas to pass into the device body 220. This obstruction filtering mechanism may rely on the density difference between the gaseous, liquidus, and solidus portions of the material inflow. The density variation corresponds to a different travel path through a pipeline curvature, allowing effective filtering as the liquidus and solidus portions of the material inflow are caught in an obstruction.

The dross suction end 210 is inserted into the liquid metal pool 111 by removing the chamber manifold 130. In the present embodiment, the dross suction end 210 is diametrically sized to be nearly the same diameter as the melt chamber 115. In some embodiments, the system the dross suction end 210 cross sectional area is greater than 70% of the melt chamber 115 cross sectional area. In other embodiments, the dross suction end 210 is reduced in diameter to fit through the wire feed port 110, the opening remaining when the wire feed port 110 is removed, or other ports allowing access to the liquid metal chamber 111. Successful dross removal can occur with various ratios of suction end 210 cross sectional area to melt chamber 115 cross sectional area.

FIG. 2B illustrates a second embodiment of a dross removal device. Dross removal device 225 reduces the number of structural elements to improve mechanical integrity and reduce assembly time. The suction end 240 can be placed into the liquid metal chamber 111, or held tightly against a temperature resistant material that acts as a fluidic coupler. A filter can be integrated in the tapered portion of the device body 245, within the fixed internal volume 230 and near the seal 235. The filter prevents ingress into the majority of the fixed internal volume 230 and allows for potential rebuild of the dross mitigation tool 225.

Similar to the fixed internal volume 201, the fixed internal volume 230 can be varied in size (by increasing the size of device body 245) to remove corresponding larger or smaller amounts of material from a liquid metal pool 111 based on the system operating conditions and user preference. Modifying the volume of the fixed internal 230 can be accomplished through any manner of modification to the device body 245 that increases the volume fluidically coupled to the fixed internal volume 230. The evacuated state in the fixed internal volume 230 is preserved by the seal 235.

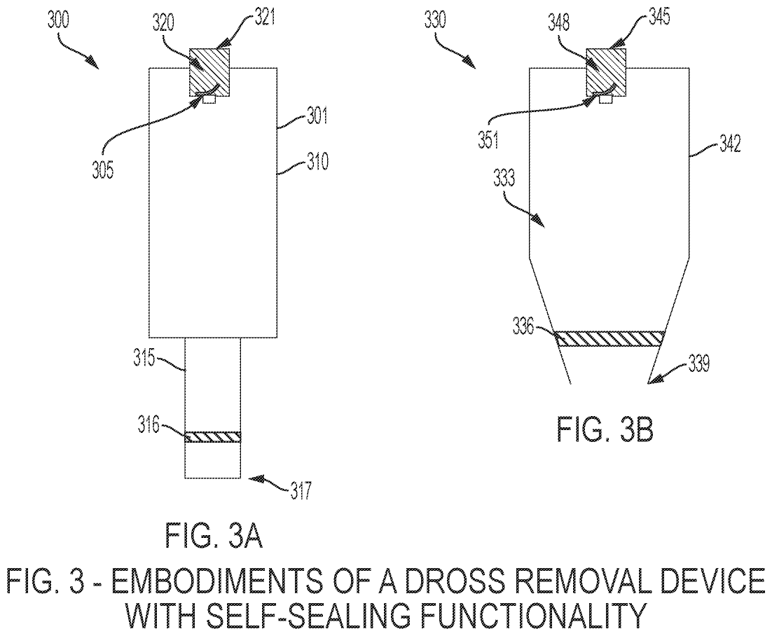

FIG. 3 illustrates additional embodiments of a dross removal device 300 that integrate a self-sealing valve into the device body. The self-sealing valve allows the fixed internal volume to be evacuated through the evacuation end by an externally applied vacuum. Once the internal pressure is sufficiently reduced, dross removal devices 300 and 330 can be disconnected from the external vacuum device and are ready for storage or operation.

In FIG. 3A dross removal device 300 has a fixed internal volume 301 that corresponds to a volume of dross to be removed. The fixed internal volume 301 is enclosed by a device body 310 that is mechanically robust enough to maintain integrity when the fixed internal volume 301 is evacuated. The device body 310 comprises a coupler member 315 and a vacuum port 320. The coupler member 315 includes a seal 316 that maintains a vacuum in the fixed internal volume 301. The coupler member 315 includes a dross suction end 317. The fixed internal volume 301 can be fluidically coupled through the coupler member 315 or evacuation port 320. The evacuation port 320 fluidically couples the fixed internal volume 301 with an exterior. The vacuum port 320 comprises a self-sealing valve 305 and an evacuation end 321.

The fixed internal volume 301 corresponds to a volume of dross to be removed. The fixed internal volume 301 may be a scaled amount greater than the volume of dross to be removed in order to account for removal efficiencies like poor seals, non—linear flow, and viscosity differences between liquid metal types. The physical geometries can be optimized to account for user operational preferences. For example, some user may choose a longer run-time between removing dross buildup, increasing the amount to be removed between each maintenance operation. To account for the increased volume of dross removal required, the fixed internal volume 301 can be increased to a volume that corresponds to a successful dross removal operation for the increased volume of dross. Alternatively, a second dross removal operation can be performed.

The evacuation port 320 includes a self-sealing valve 305 and an evacuation end 321. The self-sealing valve 320 allows the fixed internal volume 301 to be evacuated through the evacuation end 321 by an external vacuum device. The seal 316 stops pressure equalization from the dross suction end 320. The device body 310 is reusable. The coupler member 315 is reusable depending on the user assessment of obstruction from previous dross removal operations. Once the internal pressure is sufficiently reduced, dross removal device 300 is disconnected from the external vacuum device and is ready for storage or operation.

FIG. 3B illustrates a dross removal device 330 with a self sealing valve. Dross removal device 330 has a device body 342 that encloses the fixed internal volume 333. The device body 342 terminates in a suction end 339. At least the suction end 339 is a material with a higher melt temperature than the operating temperature of the liquid metal pool 111. The fixed internal volume 333 is evacuated and the evacuated state is preserved through the seal 336. The evacuation port 348 includes an evacuation end 345 and a self-sealing valve 351. The self-sealing valve 351 allows the fixed internal volume 301 to be evacuated through the evacuation end 345 by an external vacuum device.

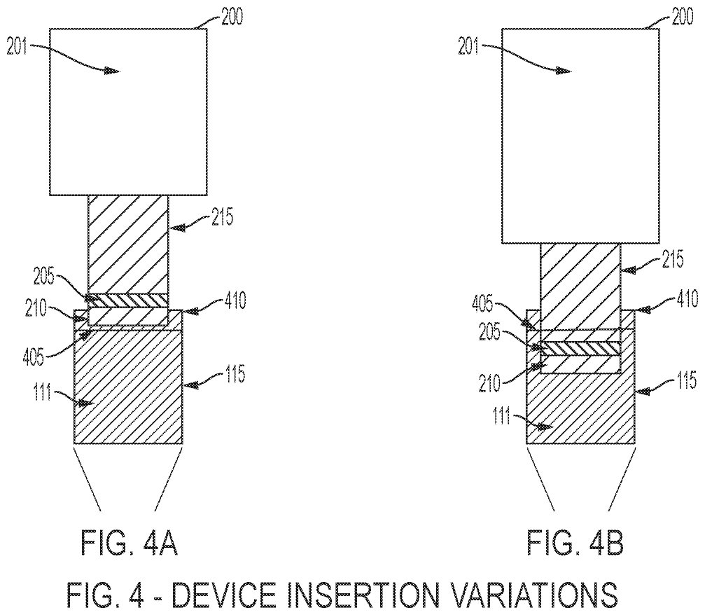

FIG. 4 illustrates the dross removal device 200 inserted into the melt chamber 115 in two configurations. The dross removal device 200 (or any embodiment of the dross removal tool disclosed) successfully operates whether immersed in the liquid metal pool or in close proximity to the surface. In FIG. 4a, the dross suction end 210 of the device coupler member 215 is inserted into the melt chamber 115 to a close proximity with the liquid level 405. In FIG. 4b the dross suction end 210 of the device coupler member 215 is inserted into the metal chamber 115 into the liquid metal pool 111, below the liquid level 405. Heat is transferred from the melt chamber 115 and liquid metal pool 115 to the coupler member 215. The temperature of the couple member 215 increases, and in turn increases the temperature of the seal 205. The seal 205 maintains the evacuated state of the dross removal device 200 until the material properties of the seal 205 are diminished by the increased heat. The material properties of the seal 205 mechanically compromise due to the increased heat and the evacuated fixed internal volume 201 is fluidically coupled to the volume in the melt chamber 115. The pressure equivalization between the fixed internal volume 201 and the melt chamber 115 cause a flow of material into the coupler member 215. The material flow is composed of solidus dross and the liquidus metal used in the print system. Material flow ceases when the fluidically coupled chambers are about equal in pressure, or an obstruction blocks the coupler member 215. One or more additional dross removal devices 200 can be utilized in a single dross removal effort if an obstruction in the coupler member 215 occurs. After the dross and some amount of liquid metal is removed from the melt chamber 115, the dross removal tool 200 is removed.

The dross suction end 210 is sized to be most of the cross-sectional area of the melt chamber 115. The dross suction end 210 may be any shape. The melt chamber 115 may be circular, rectangular, or any other shape. A circular dross suction 210 end may be used on a non-circular melt chamber 115.

The liquid level 405 may vary in the melt chamber 115. The length of the coupler member 215 ensures the dross suction end 210 can be inserted below the liquid level 405 at all levels. The distance between the dross suction end 210 and the liquid level 405 may vary based on the user's chosen operating scheme. In some embodiments, the dross suction end 210 is placed below the floating dross conglomeration. In other embodiments, the dross suction end 210 is placed above the floating dross conglomeration. Dross accumulates from multiple sources, but a large factor of dross accumulation is proportional to the amount of wire (or equivalent feed stock) fed into the melt chamber. A user may determine a longer or shorter run time is desirable, which impacts the dross accumulation between maintenance. The dross suction end 210 may be inserted to varying depths into the melt chamber 115 to remove the dross accumulation. In some embodiments, the coupler member 215 may include stops or bends at specific distances from the dross suction end 210 to support a user inserting the dross removal device 200 to a specific level. The stops or bends are geometries in the coupler member 215 that cannot pass through the chamber access 410 opening. This ensures the appropriate insertion depth. In other embodiments, the coupler member is sized to hit the bottom of the melt chamber 115. The dross suction occurs in holes distal to the end contacting the melt chamber 115 bottom surface. Upon seal 205 compromise, the dross is pulled into holes along the coupler member 215 length.

The volume of the fixed internal volume 201 corresponds to a target volume to be removed from the melt chamber 115. In some embodiments, the majority of the liquid metal pool 111 is removed by the dross removal device 200 to ensure dross removal.

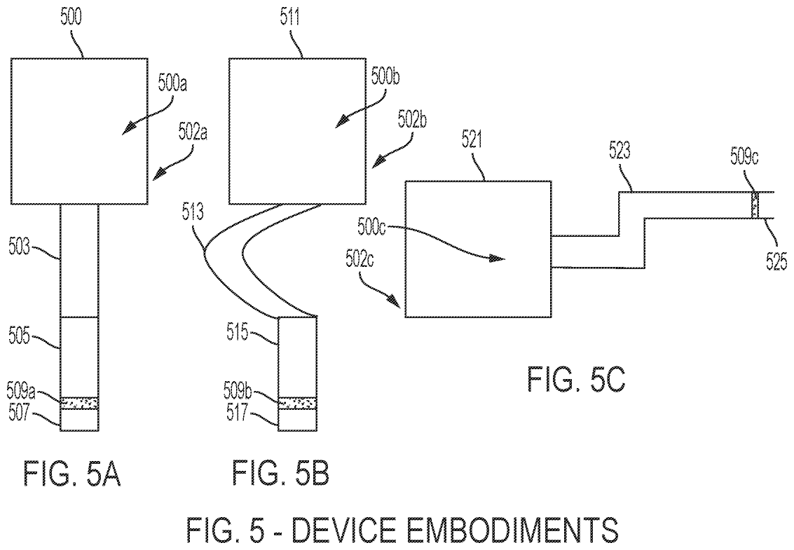

FIG. 5 shows various embodiments of dross removal devices. Dross removal device 500 shows a coupler member comprising at least two materials. Dross removal device 511 shows a coupler member comprising at least two materials with a highly flexible portion. Dross removal device 521 shows a coupler member with geometry that prevents material inflow to the device body.

The dross removal device 500 comprises a device body 502a surrounding a fixed internal volume 500a. The device body 502a attaches to a coupler non-metal length 503. The coupler nonmetal length 503 connects to a coupler temperature resistant length 505. The coupler temperature resistant length 505 ends at the dross suction end 507. A seal 509a is located along the length of the coupler temperature resistant length 505.

The dross removal device 511 comprises a body 502b surrounding a fixed internal volume 500b. The device body 502b attaches to a flexible coupler length 513. The flexible coupler length 513 connects to a coupler temperature resistant length 515. The coupler temperature resistant length 515 ends at the dross suction end 517. A seal 509b can be located along the length of the coupler temperature resistant length 515.

The dross removal device 521 comprises a body 502c surrounding a fixed internal volume 500c. The device body 502c attaches to a coupler member 523 with geometries that create a tortuous flow path for material inflow from the suction end 525 towards the device body 502c. The tortuous path can include any geometry that inhibits the path of the flow. The coupler member 523 terminates in a suction end 525. A seal 509c can be located along the length of the coupler member 523.

The coupler member 523 creates a tortuous flow path for material inflow from the suction end 525 towards the device body 502c. An effective tortuous path prevents material inflow from reaching the device body 502c. The tortuous flow path is created by changing direction of the coupler member 523, which slows or stops the inflow movement and forces it in a new direction. As the inflow moves through the coupler member cooling occurs as the dross removal tool is at a lower temperature than the melt chamber 115. The temperature decrease causes portions of the inflow to solidify, further slowing or stopping the material inflow. In some embodiments, the coupler member 523 has a single direction change of a higher angle. In other embodiments, the coupler member 523 has multiple direction changes of smaller angles. The coupler member 523 is highly customizable based on the user or use case; numerous configurations varying turn radius and quantity can be an effective tortuous path.

In some embodiments, the dross removal devices disclosed can be distributed in a kit. The kit can comprise a dross removal tool, a melt chamber corresponding to the metal printing system the user is servicing, and a plurality of coupler members. Depending on the embodiment of the dross removal tool, all or a portion of the coupler member may be supplied in the kit. For example, the plastic portion of a coupler member may be reused while the metallic insertion portion with the seal may be replaced, so the kit would comprise a supply of the metallic portions with non-compromised seals to be connected to the plastic portion of the coupler member. The kit may also include any necessary components for sealing, maintaining, storing, or using the dross removal tool. This may include o-rings, clamps, fasteners, custom tools, templates, or other miscellaneous components necessary to maintain and service a 3D metal printer.

In some embodiments, the method for evacuating the dross removal tool comprises assembling the device in an evacuated chamber. The device body and coupler member are inserted into an evacuated chamber. The coupler member comprises a first suction end, a second attachment end, and a seal. The device body assembly comprises a fixed internal volume. An airtight seal is formed when the device body and coupler member are connected in the evacuated chamber. After connection, the device is removed from the evacuated chamber.

In other embodiments, the method for evacuating the dross removal tool comprises using an external vacuum source. The coupler member comprises a first suction end and a second attachment end. The device body assembly comprises a fixed internal volume. The device body and coupler member are connected. A vacuum source is connected to the coupler member assembly and the fluidically coupled volumes are evacuated. While the evacuated state is present, a seal is inserted into the member to maintain the evacuated state. The assembly is airtight.

In other embodiments, the method for evacuating a dross removal device comprises using an external vacuum source. The coupler member comprises a first suction end, a second attachment end, and a seal. The device body assembly comprises a fixed internal volume, a self-sealing valve, a first connection for the coupler member, and a second connection port for a vacuum source. The device body and coupler member are connected and airtight when assembled. A vacuum source is connected through the second connection port and an evacuated state is developed in the fluidically coupled volume. After a threshold is reached, the vacuum source is removed.

What is claimed is:

1. A method for removing dross from molten metal in a chamber, comprising:
inserting a dross removal tool into the chamber wherein the dross removal tool comprises:
a container defining an evacuated volume;
a suction end; and
a seal disposed between the suction end and the evacuated volume compromising the seal, thereby connecting fluidically the container and the chamber;
removing a quantity of dross.

2. The method of claim 1, wherein the seal is compromised through thermal energy absorbed from the insertion environment.

3. The method of claim 1, wherein the seal comprises a solder.

4. The method of claim 1, wherein the suction end cross sectional area is greater than 80 percent of the chamber cross sectional area.

5. The method of claim 1, wherein the dross removal tool further comprises a coupler member with a first end attached to the container and a second end being the suction end.

6. A dross removal tool for removing dross from molten metal in a chamber, comprising:
a container defining an evacuated volume, comprising:
a device body;
a suction end; and
a seal between the evacuated volume and the suction end.

7. The dross removal tool of claim 6, wherein the device body comprises a plastic composition.

8. The dross removal tool of claim 6, wherein the seal comprises a solder.

9. The dross removal tool of claim 6, wherein the device body transitions to an insertion portion of less than 10% the size of the device body.

10. The dross removal tool of claim 6, further comprising a coupler member comprising a hollow structure with a first end attached to the device body and a second end being the suction end.

11. The dross removal tool of claim 10, wherein the coupler member comprises a metallic length.

12. The dross removal tool of claim 10, wherein the coupler member comprises a polymer length.

13. The dross removal tool of claim 10, wherein the coupler member has at least one bend greater than 45 degrees.

14. A dross removal tool, comprising:
a container defining an evacuated volume, comprising:
a device body;
a self-sealing valve;
a suction end; and
a seal between the suction end and the evacuated volume.

15. The dross removal tool of claim 14, wherein the seal comprises solder.

16. The dross removal tool of claim 14, wherein the device body comprises a plastic composition.

17. The dross removal tool of claim 14, further comprising a coupler member comprising a hollow structure with a first end attached to the device body and a second end being the suction end.

18. The dross removal tool of claim 17, wherein the coupler member has at least one bend greater than 45 degrees.

19. The dross removal tool of claim 17, wherein the coupler member comprises a metallic length.

20. The dross removal tool of claim 17, wherein the coupler member comprises a polymer length.
